(19) United States
(12) Patent Application Publication
(10) Pub. No.: US 2007/0157972 A1
(43) Pub. Date: Jul. 12, 2007

(54) One way check valve for a fire hydrant water meter

(76) Inventor: Arthur A. Hendey, Beaumont, CA (US)

Correspondence Address: LAW OFFICES OF MORLAND C FISCHER, 2030 MAIN ST, SUITE 1300, IRVINE, CA, 92614, US

(21) Appl. No.: 11/329,844

(22) Filed: Jan. 12, 2006

(51) Int. Cl. F16K 15/06

(52) U.S. Cl. 137/541; 137/542

(57) ABSTRACT

A one way check valve to be coupled between a fire hydrant water meter that is connected to a fire hydrant and a fire hose that is connected to a water holding tank such as, for example, a fire engine tanker truck to be filled with water from a municipal water supply. The one way check valve includes a spring- biased blocking head which is movable through the check valve from a first position, at which to close a set of fluid passages through the check valve, to a second position, at which to open the set of fluid passages to the flow of water from the fire hydrant. A shaft extends from the blocking head, and a coil spring is wound around the shaft. When water is flowing into the check valve from the fire hydrant and the fire hydrant water meter, the corresponding water pressure causes the water blocking head to move to the second position during which the spring is compressed and the fluid passages are opened to permit the flow of water to the holding tank. When water stops flowing from the fire hydrant and the water pressure is eliminated, the spring will expand and drive the water blocking head to the first position during which the fluid passages are closed to block the backflow of water from the holding tank to the fire hydrant via the fire hose and the fire hydrant water meter.

### BACKGROUND OF THE INVENTION

1. Field of the Invention

This invention relates to a one way check valve to be coupled between a fire hydrant water meter connected to a fire hydrant and a fire hose connected to a water holding tank (e.g., a fire engine tanker truck) to prevent the backflow of non-potable water from the holding tank and the water hose to the fire hydrant so as to prevent a possible contamination of the municipal water supply with which the fire hydrant is associated.

2. Background Art

Water meters have long been employed to measure the volume of water that is consumed at a source. For example, a tanker truck employed by fire departments and construction companies alike must have an available water supply to be transported from place to place. Because of the large volume of water required to meet their demands, such tanker trucks are typically filled at a fire hydrant via a fire hose, or the like. A water meter is coupled to the fire hydrant so as to measure the volume of water that is withdrawn from the water supply of a local municipality. Once the truck is filled, an indication of water use is recorded so that the municipality can issue a charge to the user in order to request reimbursement for its water consumption at the fire hydrant.

During the process of filling the tanker truck, a rupture in the water main of the municipality to which the fire hydrant is linked has been known to cause the water stored within the tanker truck to be suctioned therefrom and introduced back to the municipal water supply. Such backflow of water from the tanker truck is often characterized by potentially harmful bacteria. That is to say, by the time the water main has been repaired, the water supply of the municipality may be contaminated by the backflow of water from the tanker truck via the fire hose and the fire hydrant such that the public could be placed at risk to potential illness. In this same regard, water-borne microbes are known to reside in the fire hose connected between the water meter and the tanker truck. Such a fire hose provides an additional source of contamination in the event of water backflow from the truck to the fire hydrant.

To reduce the possibility of the backflow of non-potable water from a tanker truck and/or a fire hose to a municipal water supply at a fire hydrant, water meters have incorporated therein unidirectional flow control devices. Reference in this regard may be made to U.S. Pat. No. 6,363,782 issued Apr. 2, 2002 to Arthur A. Hendey for an example of a reliable fire hydrant water meter in which one way check valve means are included. However, a fire hydrant water meter having a unidirectional flow control device may not be readily available at the time or place during which the tanker truck must be filled with water from a municipal fire hydrant.

Therefore, what is needed is a compact, portable and easy-to-connect unidirectional flow control means that is adapted to be coupled between a fire hydrant water meter and a fire hose to permit a tanker truck to be filled with water from a municipal water supply, but without subjecting the public to possible illness as a consequence of water backflow from the truck and the fire hose towards the fire hydrant.

### SUMMARY OF THE INVENTION

In general terms, a one way check valve is disclosed to be coupled between a fire hydrant water meter that is connected to a fire hydrant and a fire hose that is connected to a water holding tank (e.g., a fire engine tanker truck) so that the holding tank can be filled with water from a municipal water supply to which the fire hydrant is linked. The one way check valve prevents water backflow from the holding tank and the fire hose to the fire hydrant so as to avoid a possible contamination of the municipal water supply as a consequence of potentially harmful bacteria and microbes that reside within the holding tank and/or the fire hose. The check valve includes a fire hose nipple having first and opposite screw threaded ends that are adapted to be rotated into respective mating engagement with the fire hydrant water meter and the fire hose.

A check valve actuator is located inwardly of the fire hose nipple. A plurality of water flow passages run through the check valve actuator between the first and opposite ends of the nipple. The check valve actuator includes a stationary spring shaft support having a shaft guide. A spring shaft is slidably received by the shaft guide. At one end of the spring shaft is a water blocking head that is movable relative to the stationary spring shaft support between a first position, at which to lie against and close the plurality of water flow passages through the check valve actuator, to a second position spaced from the water flow passages, at which to open a fluid path through the check valve from the fire hydrant to the fire hose by way of the water flow passages. At the opposite end of the spring shaft is a spring support head. A coil spring in a normally relaxed and expanded condition is wound around the spring shaft between the shaft guide and the spring support head.

In its relaxed and expanded condition, the coil spring exerts a pulling force against the spring support head of the spring shaft to urge the water blocking head to the first position at which to close the plurality of water flow passages through the check valve actuator so as to block the fluid path and thereby prevent the backflow of water from the holding tank and the fire hose to the fire hydrant. However, when water flows from the fire hydrant through the water flow passages, a water pressure is generated to push the water blocking head to the second position at which to open the plurality of water flow passages through the check valve actuator and thereby establish the fluid path from the fire hydrant to the holding tank via the fire hose. At the same time, the spring shaft connected to the water blocking head slides in a first direction through the shaft guide of the stationary spring shaft support and the coil spring wound around the spring shaft is compressed to store energy. When water stops flowing from the fire hydrant through the water flow passages of the check valve actuator and the water pressure is eliminated, the spring is allowed to expand and release its stored energy, whereby to cause the spring shaft to slide in an opposite direction through the shaft guide. Accordingly, the water blocking head is pulled by the spring shaft back to its first position against the water flow passages to once again block the flow path to water backflow.

### BRIEF DESCRIPTION OF THE DRAWINGS

FIG. 1 is a first exploded view of a one way check valve according to a preferred embodiment of the present invention;

FIG. 2 is another exploded view of the one way check valve of FIG. 1;

FIG. 3 shows a side view of the one way check valve of FIGS. 1 and 2 in the assembled condition;

FIG. 4 shows a first end view of the one way check valve in the assembled condition;

FIG. 5 shows a perspective view of the one way check valve in the assembled condition;

FIG. 6 shows an opposite end view of the one way check valve in the assembled condition;

FIG. 7 is a cross-section of the one way check valve in a closed configuration with a water blocking head located at a first position so as to block a water flow path through the check valve;

FIG. 8 is a cross-section of the one way check valve in an open configuration with the water blocking head located at a second position so as to establish a water flow path through the check valve;

FIG. 9 is an exploded view of the one way check valve to be detachably coupled between a fire hydrant water meter and a fire hose; and

FIG. 10 shows the one way check valve coupled between the fire hydrant water meter and the fire hose.

### DESCRIPTION OF THE PREFERRED EMBODIMENT

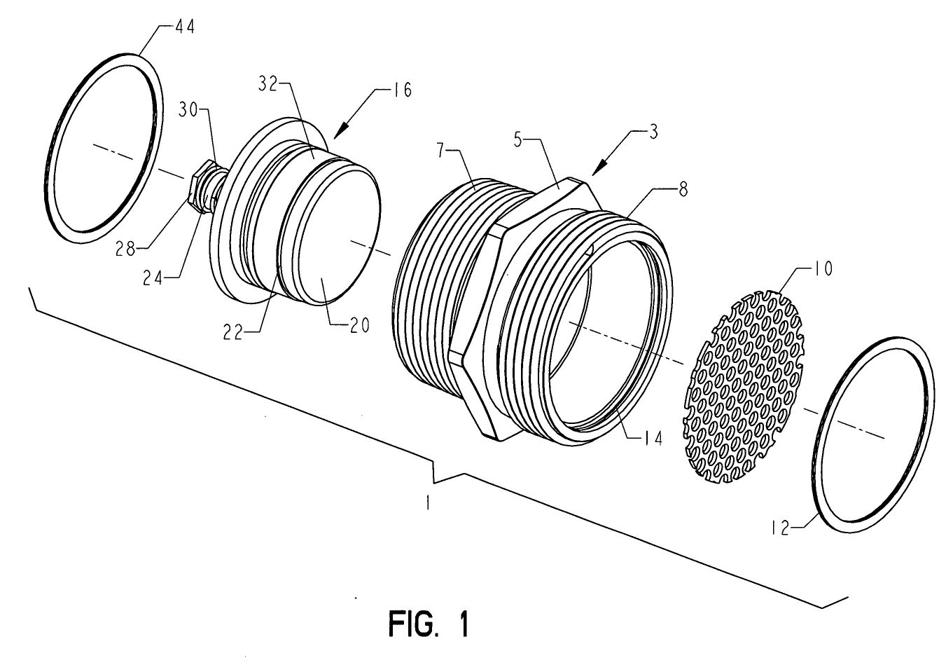

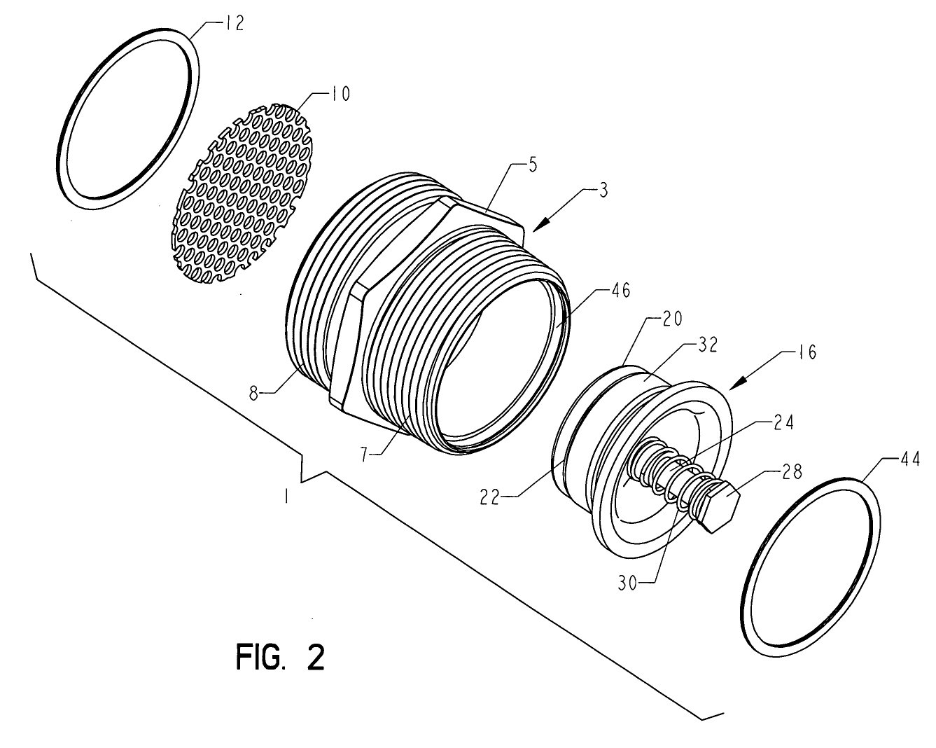

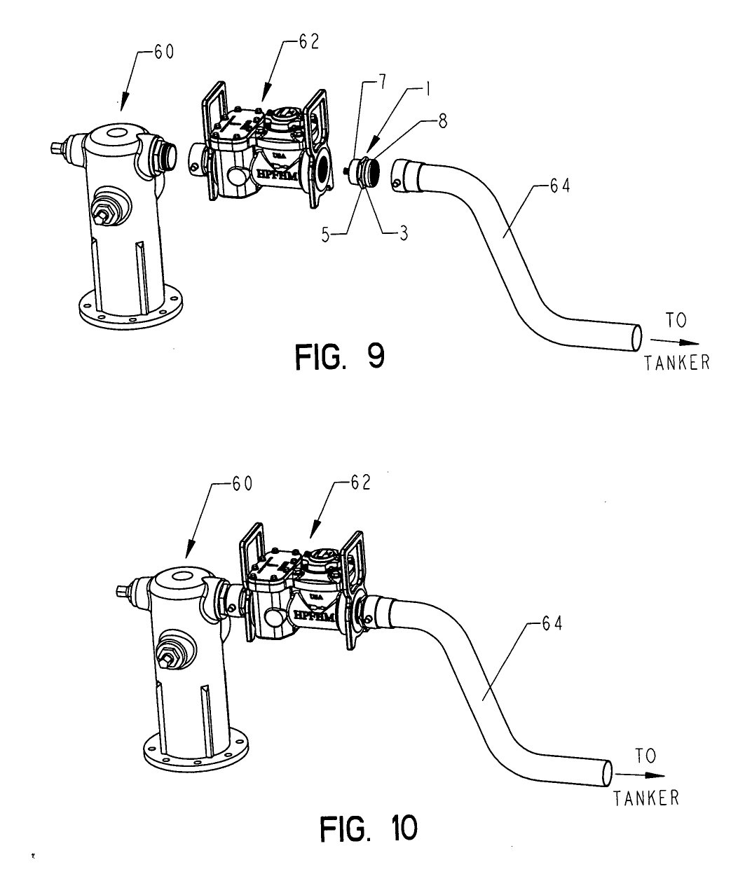

Referring initially to FIGS. 1 and 2 of the drawings, there is shown exploded views of a one way check valve 1 according to a preferred embodiment of this invention. The check valve 1 includes a fire hose nipple 3 having a hollow valve body and a hex fitting 5 extending therearound to which a torquing force is applied to impart a rotation to the valve body. Fire hose nipple 3 is preferably manufactured from brass or anodized aluminum. However, the precise material from which nipple 3 is manufactured is not to be regarded as a limitation of this invention. The hollow valve body of fire hose nipple 3 has opposite screw-threaded ends 7 and 8 by which the check valve 1 can be coupled between a fire hydrant water meter and a fire hose in the manner shown in FIGS. 9 and 10.

A (e.g., stainless steel) strainer screen 10 is received inwardly of the threaded end 8 of the hollow valve body of fire hose nipple 3. The strainer screen 10 functions to keep out loose tooling and filter out debris that is carried by a water supply flowing through the fire hydrant water meter (designated 62 in FIGS. 9 and 10) to which the check valve 1 is coupled. The strainer screen 10 also functions to smooth the supply of water which originates from a fire hydrant (designated 60 in FIGS. 9 and 10) and reduce turbulence. A retainer ring 12 is located within a groove 14 formed around the threaded end 8 of the fire hose nipple 3 to hold the strainer screen 10 therewithin.

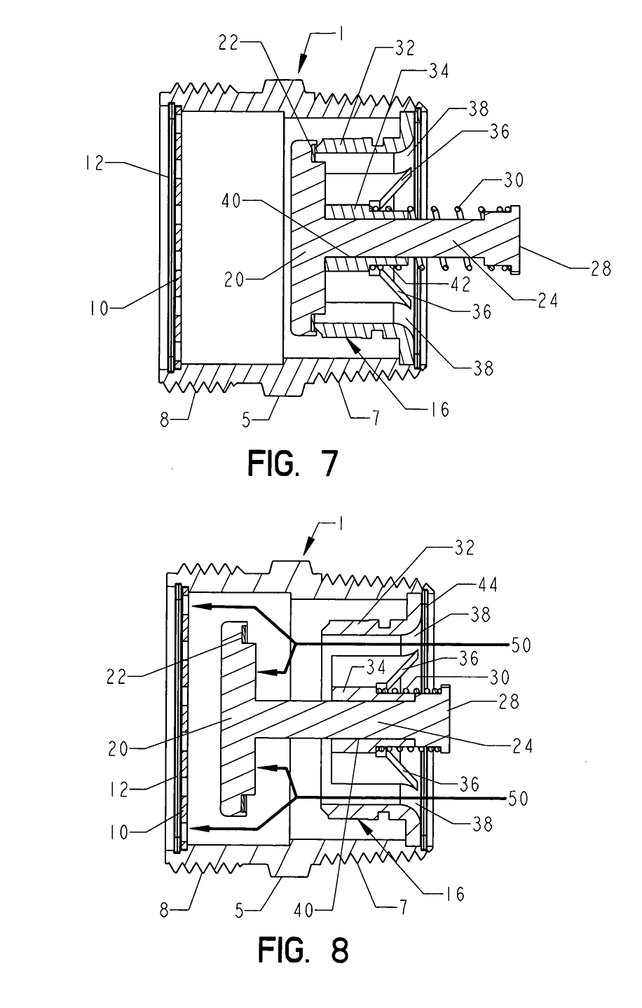

The check valve 1 includes a check valve actuator 16 to be positioned inwardly of the threaded end 7 of fire hose nipple 3. A movable seal retaining head 20 is located at one end of the check valve actuator 16. A seal 22 is seated within a groove formed around the seal retaining head 20 to prevent the leakage of water past head 20 and through actuator 16 when the check valve 1 is in a closed configuration (of FIG. 7).

As an important detail of the one way check valve 1 of this invention, a spring shaft 24 is coextensively connected at one end thereof to the seal retaining head 20 of check valve actuator 16. The opposite end of the spring shaft 24 is coextensively connected to a spring support head 28. A normally relaxed and expanded coil spring 30 is wound around and extends along the spring shaft 24.

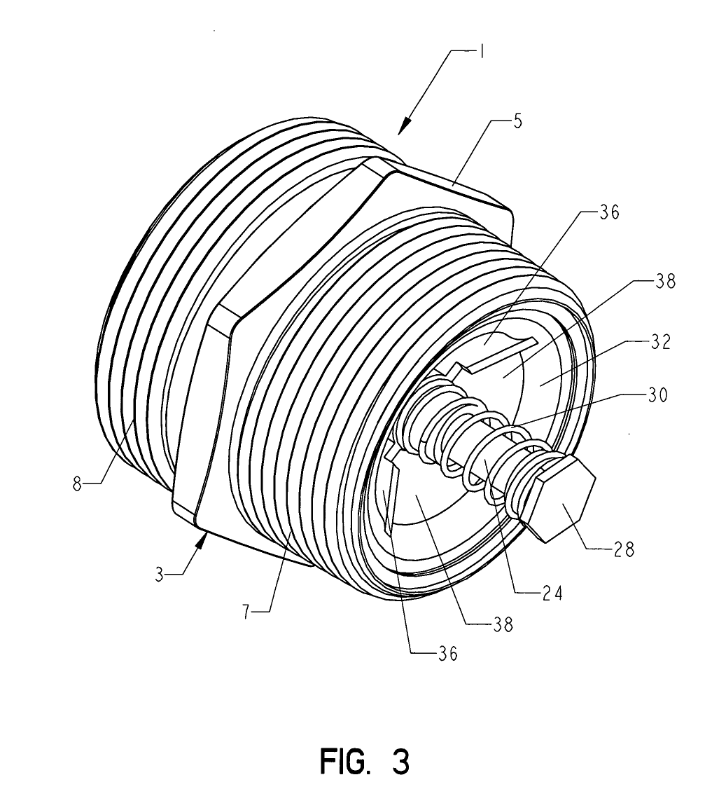

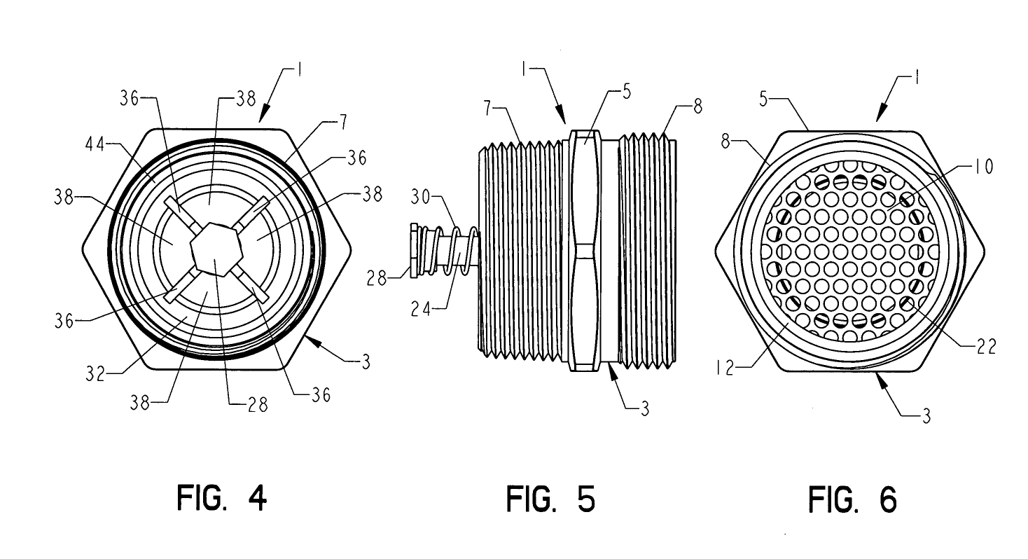

The check valve actuator 16 also includes a hollow, cylindrical spring shaft support 32 which, in the assembled configuration of the check valve 1 shown in FIGS. 3-6, is fixedly attached inside the threaded end 7 of the fire hydrant nipple 3. As is best shown in FIGS. 7 and 8, a cylindrical shaft guide 34 is held in spaced coaxial alignment within the hollow spring shaft support 32 by means of a plurality of (e.g., four) equally spaced ribs or vanes 36 extending therebetween. Accordingly, a corresponding set of water flow passages 38 (best shown in FIG. 4) are established between successive pairs of the vanes 36.

A shaft guide channel 40 runs axially through the cylindrical shaft guide 34 to slidably receive therewithin the spring shaft 24. A recess 42 is formed along the shaft guide 34 to engage one end of the coil spring 30. The opposite end of the coil spring 30 is received against the spring support head 28 at the end of spring shaft 24. As will soon be explained, the spring shaft 24 around which the coil spring 30 is wound slides axially through the shaft guide channel 40 of the shaft guide 34 in response to the pressure generated by water flowing against the seal retaining head 20 of check valve actuator 16 from the fire hydrant (designated 60 in FIGS. 9 and 10) and the fire hydrant water meter (designated 62).

The spring shaft support 32 of check valve actuator 16 is held in place within the threaded end 7 of fire hose nipple 3 by means of a retaining ring 44. As is best shown in FIG. 2, the retaining ring 44 is seated within a groove 46 extending around the threaded end 7 of nipple 3 so as to lie against and apply an inward pushing force to the spring shaft support 32 to prevent a displacement of shaft support 32 and the coaxially aligned shaft guide 34 thereof.

FIGS. 3 to 6 of the drawings show the one way check valve 1 in the assembled configuration. As is best shown in FIG. 3, the spring shaft 24 projects outwardly from the threaded end 7 of the fire hydrant nipple 3, and the coil spring 30 is wound around the shaft so as to rest against the spring support head 28. As is best shown in FIG. 4, the strainer screen 10 is located inwardly of the threaded end 8 of the fire hydrant nipple 3, and the retaining ring 12 is snap-fit within groove 14 (of FIG. 1) to hold the screen 10 therewithin. As is best shown in FIGS. 5 and 6, the check valve actuator 16 is located inwardly of the threaded end 7 of fire hydrant nipple 3, and the retaining ring 44 is snap-fit within groove 46 (of FIG. 2) to hold actuator 16 therewithin. As just explained, the retaining ring 44 also holds the stationary spring shaft support 32 of check valve actuator 16 in place inside the threaded end 7 of nipple 3. In this manner, the spring shaft 24 is permitted to slide back and forth through the shaft guide channel 40 in shaft guide 34 (of FIG. 7) to correspondingly move the seal retaining head 20 relative to the stationary spring shaft support 32 between closed and open positions, as will now be explained.

Referring in this regard to FIG. 7 of the drawings, the one way check valve 1 is shown having a closed configuration with the movable seat retaining head 20 of check valve actuator 16 at a closed position within the fire hose nipple 3 so as to be seated against the stationary shaft support 32. That is to say, with check valve 1 having the closed configuration, no water pressure is applied against the seal retaining head 20 to cause the head 20 to move off the stationary shaft support 32 and away from its closed position. In this case, no water is flowing from a water source (i.e., a fire hydrant) through the water flow passages 38 between the vanes 36 of actuator 16. The coil spring 30 which surrounds spring shaft 24 is still relaxed and expanded between shaft guide 34 and the spring support head 28 so as to generate a spring force against the spring support head 28 which causes the seal retaining head 20 to be pulled to its closed position against the spring shaft support 32. With the seal retaining head 20 of check valve actuator 16 in the closed position shown in FIG. 7, water backflow from a water holding tank (e.g., a fire engine tanker truck) and a fire hose (designated 64 in FIGS. 9 and 10) to the water source (e.g., the fire hydrant 60 of FIGS. 9 and 10) will be blocked. More particularly, the seal retaining head 20 and the seal 22 carried thereby are disposed across the water flow passages 38 through actuator 16 to prevent water stored in the holding tank from entering the check valve 1 at the strainer 10 and flowing through the flow passages 38 towards the source. Accordingly, the water source cannot become contaminated with non-potable water from the holding tank or the fire hose 64 as a consequence of backflow through the check valve actuator 16.

Referring now to FIG. 8 of the drawings, the one way check valve 1 is shown having an open configuration with the seal retaining head 20 of check valve actuator 16 moved to an open position spaced from the stationary shaft support 32 that is retained inside the threaded end 7 of fire hose nipple 3. In this case, sufficient water pressure is applied against the seal retaining head 20 to overcome the normal spring force generated by the coil spring 30 and thereby push the head 20 off and away from the shaft support 32. In particular, the water pressure is created by water flowing in the direction of reference arrows 50 from the water source (e.g., the fire hydrant 60 of FIGS. 9 and 10) to fill the water holding tank (e.g., a fire engine tanker truck) via the water flow passages 38 through the check valve actuator 16.

When the seal retaining head 20 is moved to its open position relative to the stationary spring shaft support 32 as shown in FIG. 8, the spring shaft 24 connected to head 20 will correspondingly slide axially through the shaft guide channel 40 of shaft guide 34. The normally relaxed and expanded coil spring 30 which surrounds the spring shaft 24 is now compressed between the shaft guide 34 and the spring support head 28 so as to store energy. The seal retaining head 20 and the seal 22 carried thereby are no longer located across the water flow passages 38 through actuator 16. Accordingly, a flow path is opened through the check valve 1 in the direction of reference arrows 50 through the water flow passages 38, past the seal retaining head 20, and outwardly of the strainer screen 10 so that the water holding tank might be filled with water originating from the fire hydrant.

The check valve 1 will remain in the open configuration shown in FIG. 8 as long as there is sufficient water pressure being applied against the movable seal retaining head 20 to continue to push head 20 off and away from the stationary spring shaft support 32. Once water stops flowing from the source through the check valve 1 in the direction of reference arrows 50 and the water pressure is eliminated, the previously compressed coil spring 30 will begin to expand and release its stored energy. As the spring 30 expands, a spring force will be applied against the spring support head 28 of spring shaft 24 to automatically cause the seal retaining head 20 to be pulled back to its closed position as shown in FIG. 7. The seal retaining head 20 and the seal 22 that is carried by the seal retaining head 20 are disposed across the water flow passages 38 and the flow path therethrough is closed. The check valve 1 will now have the closed configuration of FIG. 7, and the check valve actuator 16 will be once again at rest.

FIGS. 9 and 10 of the drawings show the one way check valve 1 of this invention coupled between a water source (e.g., a fire hydrant 60 connected to a municipal water supply) and a water holding tank (e.g., a fire engine tanker truck, or the like) to enable the holding tank to be filled with water. According to a preferred embodiment, a commercially available fire hydrant water meter 60 is initially coupled to the fire hydrant 60 to measure the volume of the municipal water supply that is consumed when the fire engine tanker truck is filled. By way of example only, a suitable fire hydrant water meter to be coupled to the one way check valve 1 is commercially available from Performance Meter, Inc. of Beaumont, Calif. under Part No. FHP-25D.

Next, the one way check valve 1 is coupled between the fire hydrant water meter 62 and a conventional fire hose 64. More particularly, a rotational force is applied to the hex fitting 5 of fire hose nipple 3 to cause one threaded end 7 thereof to be mated to the water meter 62 and the opposite threaded end 8 to be mated to the fire hose 64. The fire hose 64 is now connected to the fire truck to be filled with water from the municipal water supply. However, by virtue of the one way check valve 1 herein disclosed, the backflow of contaminated water from the fire truck and the fire hose 64 to the municipal water supply (by way of the water meter 62 and the fire hydrant 60) will be blocked so as to avoid potentially life threatening water-borne microbes and disease from entering the municipal supply.

I claim:

1. A one way fluid check valve, comprising:
a valve body to communicate with a source of fluid, said valve body having at least one fluid passage extending therethrough to which fluid from the source of fluid is to be supplied;
a fluid closure movable through said valve body to control the flow of fluid through said at least one fluid passage; and
a spring cooperating with said fluid closure to generate a spring force for urging said fluid closure to a first position within said valve body at which to block the at least one flow passage through said valve body, said fluid closure being responsive to a fluid pressure applied thereagainst when fluid flows into said flow passage from the source of fluid, said fluid pressure overcoming the spring force generated by said spring for pushing said fluid closure to a second position within said valve body at which to open the fluid passage and thereby permit the flow of fluid through said valve body by way of said fluid passage.

2. The one way check valve recited in claim 1, further comprising a strainer supported by said valve body so as to lie across the at least one fluid passage through said valve body.

3. The one way check valve recited in claim 1, wherein said valve body has screw threads extending therearound to enable said valve body to be coupled to the source of fluid.

4. The one way check valve recited in claim 1, wherein said fluid closure includes a fluid blocking head moving through said valve body from said first position extending across said at least one fluid passage at which to block the flow of fluid therethrough to said second position at which to open said at least one fluid passage and permit the flow of fluid therethrough.

5. The one way check valve recited in claim 4, wherein said fluid blocking head carries a fluid seal to be moved to the first position with said fluid blocking head so as to close said at least one fluid passage and thereby block the flow of fluid therethrough.

6. The one way check valve recited in claim 4, further comprising a shaft connected at one end thereof to said fluid blocking head, said spring surrounding said shaft to generate said spring force against said shaft for urging said fluid blocking head to said first position within said valve body so as to extend across and block said at least one fluid passage.

7. The one way check valve recited in claim 6, further comprising a shaft support fixedly positioned within said valve body and having a guide channel formed therein, said shaft being slidable in a first direction through said guide channel when said fluid closure moves to the second position within said valve body at which to open said at least one fluid passage and permit the flow of fluid therethrough.

8. The one way check valve recited in claim 7, wherein said shaft has a spring support head formed at the opposite end thereof, said spring extending between said shaft support and said spring support head by which to generate said spring force for urging said fluid blocking head to move to said first position.

9. The one way check valve recited in claim 8, wherein said spring is compressed between said spring support head and said shaft support to store energy when said shaft slides in the first direction through the guide channel of said shaft support, said spring expanding to release its stored energy to cause said shaft to slide in an opposite direction through said guide channel to pull said fluid closure to the first position within said valve body at which to block the at least one fluid passage through said valve body when fluid stops flowing into said flow passage from the source of fluid and the fluid pressure applied against said fluid closure is eliminated.

10. The one way check valve recited in claim 1, further comprising an actuator located within said valve body and having the said at least one fluid passage formed therein, said actuator also having said fluid closure movable through said valve body relative to said fluid passage between said first and second positions.

11. A combination including:
a water meter to be connected to a source of water;
a water conduit to carry the water from said water meter to a water holding tank; and
a one way check valve to be coupled between the water meter and the water conduit to prevent the backflow of water from the holding tank to the source of water by way of the water conduit and the water meter, said one way check valve comprising:
a valve body having at least one fluid passage extending therethrough to which water from said water meter is to be supplied;
a water closure movable through said valve body to control the flow of water through said at least one fluid passage; and
a spring cooperating with said water closure to generate a spring force for urging said water closure to a first position within said valve body at which to block the at least one flow passage through said valve body, said water closure being responsive to a water pressure applied thereagainst when water flows through said flow passage from the water meter, said water pressure overcoming said spring force generated by said spring for pushing said water closure to a second position within said valve body at which to open the fluid passage and thereby permit the flow of water through said valve body by way of said fluid passage.
